(19) United States
(12) Patent Application Publication
(10) Pub. No.: US 2024/0382865 A1
(43) Pub. Date: Nov. 21, 2024

(54) Dirt mixture for use in horse racing and equestrian sports

(71) Applicant: Wendy Ouriel, Irvine, CA (US)

(72) Inventor: Wendy Ouriel, Irvine, CA (US)

(21) Appl. No.: 18/198,857

(22) Filed: May 18, 2023

(51) Int. Cl. A63K 1/00; C09K 17/16

(52) U.S. Cl. CPC A63K 1/00; C09K 17/16

(57) ABSTRACT

The present invention relates to a novel method of dirt mixture wherein seaweeds are added to provide the expected bounce, wherein as the product is totally developed from natural ingredients so doesn't pose any health concerns to individuals and animals.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The present invention relates to the field of soil or dirt mixture and more particularly relates to novel mixture of seaweeds and dirt mixture that will be used as the racing surface for horse racing tracks and for the surface for use in equestrian sports.

### Description of the Related Art

As used herein and throughout, the terms in quotations below are defined as follows: The term “soil” refers to particulate surface material of the earth, whether or not it contains organic matter, and includes one or more of sand, silt, clay and crushed rock such as decomposed granite. The term “sand” refers to any granular material formed by the disintegration of rocks to form particles smaller than gravel but coarser than silt. Sand may or may not include organic matter. The term “silt” refers to any unconsolidated sedimentary material with rock particles usually 1/20 millimeter or less in diameter, and being generally smaller than sand but coarser than clay. Silt may or may not include organic matter. The term “clay” refers to any (1) inorganic earth surface material that is plastic when moist but hard when fired and that is comprised primarily of hydrous aluminum silicates and/or other minerals, or (2) substance having the properties of clay. Clay includes dry or wet materials and may or may not include organic matter. The term “organic binder” refers to any organic matter that tends to bind soil particles together when mixed with the soil particles, wetted and subsequently dried. Organic binders include dried and ground plantago. The term “carrier” refers to any material that is granular (or particulate) at room temperature and that, when mixed with oil and polymeric binder, forms a soil conditioning product that may be mixed with soil as a granular material rather than as a liquid. The carrier is preferably an organic binder such as dried and ground plantago. The term “fibers” refers to any fibers, ribbons or strips of material used to add mechanical strength to soil. The term “oil” means any substance, such as soy bean oil, cotton seed oil, petroleum oil, or mineral oil, into which a polymeric binder can be dispersed or dissolved and that when mixed with a carrier and a polymeric binder yields a soil conditioning product.

It is known to mix organic binder with soil to create an improved surface material and such a process and product are disclosed in U.S. Patent No. Re. 35,989 to Hubbs et al. A basic description of one process according to that invention is to mix dried and ground plantago with soil, place the mixture on the ground in preferred depths of 2″-6″; wet the mixture, compress it and allow it to dry. The resulting surface is hard and this product and process may be used, for among other things, to form a surface on highway berms, parking lots, golf cart paths, walking paths, or baseball infield base paths. While this product has been successful, it must be wetted thoroughly and compacted to create a good surface. Operator error in either of these steps can lead to a less than desirable finished product. Further, before being wetted there is no adhesion between the soil and organic soil binder, so it is difficult to position the material on a slope since the mixture tends to slide down the slope. Additionally, the resulting surface is not water resistant.

Another known way to condition soil is to simply use a polymeric binder. Known polymeric binders are usually solid, tacky materials at temperatures below 1000F and must be heated (into a syrup-like consistency) and mixed with soil, which is a time consuming and difficult process. U.S. Pat. No. 5,559,166 to Beardon discloses a ground surface material comprising sand and at least one of clay or silt and a binder including an interpolymer polymeric binder dissolved or dispersed in a non or low aromatic oil. The binder is generally fluid at soil treating conditions and an aqueous emulsion of the binder may be sprayed onto existing dirt. U.S. Pat. No. 4,792,133 to Hawkins et. al., discloses a substitute ground surface material comprising about 94 percent sand or a like material which is added to a polymeric binder comprising 10 percent polymeric material, such as ethylene vinyl acetate, polystyrene, nylon, polypropylene or polyvinyl chloride, dissolved in an oil that is generally a non-free flowing grease at normal track operating conditions.

U.S. Pat. No. 4,852,870 to Hawkins et al. discloses a substitute ground surface material suitable for use as the rakable “cushion” portion of a horse or dog race track. As disclosed, the substitute ground surface material comprises about 94 percent sand or a like material which is added to a binder comprising 10 percent styrene-butadiene-styrene copolymer dissolved in an oil that is generally non-free flowing grease at normal track operating conditions. Other disclosed polymers include polypropylene. The resulting coated substitute ground surface material, which is permanently capable of being raked, is then laid as a cushion layer over a subsoil or suitable porous graded base, with the top of the cushion maintained by raking.

U.S. Pat. No. 4,968,024 to Hawkins discloses a substitute ground surface material suitable for use as the rakable “cushion” portion of a horse or dog race track. As disclosed, the substitute ground surface material comprises 98 percent sand or a like material which is added to binder comprising 20 to 40 percent styrene-butadiene-styrene copolymer dissolved in an aromatic oil that is generally free-flowing at normal track operating conditions. The resulting coated substitute ground surface material, which is permanently capable of being raked, is then laid as a cushion layer over a subsoil or suitable porous graded base, with the surface maintained by raking and light rolling.

EP 0 419 170 A3 published Mar. 27, 1991 discloses a substitute ground surface material suitable for use as the rakable “cushion” portion of a horse or dog race track. As disclosed, the substitute ground surface material comprises from 93.5 to 98 weight percent sand or a like material which is added to binder comprising 10 to 60 weight percent styrene-butadiene-styrene copolymer dissolved in an aromatic oil that is generally free-flowing at normal track operating conditions. The resulting coated substitute ground surface material, which is permanently capable of being raked, is then laid as a cushion layer over a subsoil or suitable porous graded base, with the top of the cushion maintained by raking. The disclosures of U.S. Pat. Nos. 5,746,546 and 6,821,332 to Hubbs are incorporated herein by reference.

The current invention discloses a new method of combining seaweed with dirt to produce a mixture that provides the required bounce and as compared to prior approaches is economical, natural in nature, and doesn't pose any health damages to the animal and individuals.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims and abstract as a whole.

The primary objective of the invention is to overcome the limitations of the existing dirt mixture process and provide a new approach that overcomes the disadvantages of prior techniques.

Another objective of the invention is to provide a combination of seaweed and dirt mixture to facilitate horse racing tracks and equestrian arenas.

Furthermore, the invention aims to provide a new, straightforward, effective, and inexpensive approach.

It is also the objective of the invention to provide seaweed that in dirt gives the dirt to bounce naturally.

Additionally, the invention emphasizes ease of use and convenience wherein Seaweed poses no known threat to a horse's health and the mixture holds a lot of promise for improving a horse's performance and protecting their safety during a race.

It is also the objective of the invention to provide a natural approach that is recyclable in nature and also the consumption of seaweed will reduce the high cost of cleaning.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention provides a novel method of a dirt mixture with seaweed together used to facilitate the horse racing track and equestrian arena.

The present invention relates to soil conditioning products, processes for making the same, surface materials including soil and seaweed, and processes for making the same. The dirt mixture product according to the invention preferably includes soil and seaweed. Other constituents may be added to any of these soil conditioning products.

The use of seaweed in dirt gives the dirt to bounce naturally. Seaweed poses no known threat to a horse's health and the mixture holds a lot of promise for improving a horse's performance and protecting their safety during a race. Furthermore, seaweeds are natural and don't pose any threat to the environment.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A dirt mixture for use in horse racing comprising:
Seaweeds; and,
Dirt mixture.
The method as per claim 1, involves a mixture that provides natural bounce as expected from other prior approaches.
The method as per claim 1, involves a mixture developed from natural material and poses no threat to the environment.
The method as per claim 1, involves a mixture developed from natural material and has no health implications for individuals and animals.
